(19) United States
(12) Patent Application Publication
(10) Pub. No.: US 2013/0124101 A1
(43) Pub. Date: May 16, 2013

(54) METHOD FOR DETECTING MAGNETICALLY MARKED OBJECTS AND CORRESPONDING DEVICE

(71) Applicant: Helmut Eckert, Rottenbach (DE)

(72) Inventor: Helmut Eckert, Rottenbach (DE)

(21) Appl. No.: 13/698,587

(22) PCT Filed: Apr. 13, 2011
(86) PCT No.: PCT/EP2011/055747

§ 371 Date: Nov. 16, 2012

(30) Foreign Application Priority Data
May 18, 2010 (DE) 10 2010 020 784.5

(51) Int. Cl. G06F 19/10

(52) U.S. Cl. CPC G06F 19/10
USPC 702/21

(57) ABSTRACT

Magnetically marked objects, in particular biological objects, such as cells, are continuously detected by moving at least one magnetically marked object in a magnetic field, measuring a local change in the magnetic field caused by the magnetically marked object, generating a signal, in particular a digitized signal, based on the measured local change in the magnetic field, conditioning the generated signal by at least one convolution of the generated signal using a mathematical function, and evaluating the conditioned signal. The evaluation of the signal includes determining extreme values, in particular maximum values, of the signal and comparing the determined extreme values with a threshold value, in particular a predefined threshold value, which, if exceeded, indicates detection of the object.

### CROSS REFERENCE TO RELATED APPLICATIONS

This application is the U.S. national stage of International Application No. PCT/EP2011/055747, filed Apr. 13, 2011 and claims the benefit thereof. The International Application claims the benefit of German Application No. 102010020784.5 filed on May 18, 2010, both applications are incorporated by reference herein in their entirety.

### BACKGROUND

Described below is a method for detecting, in particular continuously detecting, magnetically marked objects, in particular biological objects, such as cells, a corresponding sensor device, a corresponding device and a use.

Methods and devices of the aforesaid kind are used for example to identify and/or count objects that have a specific feature. If, for example, a specific number of marked cells are found in the blood of a patient, it is possible to diagnose a disease.

In order to enable cells to be detected, they can for example be magnetically marked so that the magnetically marked cells can be detected by a magnetoresitive sensor element in that changes in an external magnetic field that are caused by the magnetically marked cells are measured.

WO 2008/001261 discloses a magnetic sensor device and a method for detecting magnetic particles. The magnetic sensor device in this case includes a magnetic field generator, a sensor unit and a combining unit. In this solution the magnetic field can be generated in different magnetic field configurations. The magnetic field configurations correspond here to a plurality of different magnetic excitation states of the magnetic particles.

US 2008/0024118 A1 also discloses a sensor device and a method for detecting the presence of at least one magnetic particle. In this case the sensor device includes a magnetic field generator and at least one magnetic sensor element. In order to ensure that the magnetic particles do not approach too close to the at least one magnetic sensor element and thereby make their detection by the sensor element more difficult, an exclusion zone having a thickness of between 1 μm and 300 μm is provided between the magnetic sensor element and the magnetic particle in the vicinity of the at least one magnetic sensor element.

US 2007/269905 A1 describes a method for measuring a magnetic field of magnetic particles using a sensor array.

US 2009/033935 A1 describes a sensor for detecting magnetic nanoparticles in which the magnetic nanoparticles are irradiated by a laser and in which the magnetic nanoparticles are detected on the basis of a photocurrent.

US 2009/278534 A1 describes a sensor for sensing magnetic particles using an arrangement for generating magnetic fields of different field configurations and a sensor for detecting the influence of the magnetic particles on the magnetic fields.

### SUMMARY

The method has an advantage in that magnetically marked objects, in particular biological objects, such as cells, can be detected easily and reliably in spite of a small signal-to-noise ratio during the detection of the objects. Since a shape of the generated signal is also dependent on external parameters, for example characteristics of a sensor, external parameters of the kind can also be used for conditioning the generated signal, with the result that the detection of the magnetically marked objects can be improved even further. If the object has been detected, i.e. an amplitude of the conditioned signal lies above the threshold value, further information still, for example concerning the physical properties of the cell such as, for example, diameter, etc., can be obtained from the amplitude value of the generated signal. In addition it is also easily possible to establish in the course of the evaluation simply that the threshold value of the amplitude of the conditioned signal has been exceeded, and thus confirm only the existence of an object within the range of the sensor. If a plurality of objects pass within the range of the sensor in succession, the number of objects can be determined in this way.

According to a further advantageous development, the magnetic field is oriented substantially vertically with respect to a direction of movement of the objects, in particular wherein changes in the magnetic field caused by changes in a magnetic flux density on account of the magnetically marked object are measured in parallel with the direction of movement of the object. The advantage here is that as a result the sensitivity of a sensor for detecting the objects is as great as possible, since then a measured change in the magnetic field is dependent only on the magnetic flux density changed by the magnetically marked object. Detection of an object is accordingly made possible in a simple and reliable manner.

According to a further advantageous development, the change in the magnetic field is measured by a Wheatstone bridge. The advantage here is that as a result of the measurement by a Wheatstone bridge, which generally has four resistors, a different curve of the generated signal due to the magnetically marked object sliding over or past at least two resistors is possible which allows a more accurate evaluation or resolution of an extreme value of the respective objects and consequently an improved detection of the objects. Furthermore it is equally possible to allow the magnetically marked object to pass over more than two, in particular the four, resistors of the Wheatstone bridge. The resistors can then be arranged such that the cell is large in comparison with the spatial extension of the four resistors, in other words, therefore, that when the object slides past the four resistors a single signal is generated which nonetheless has the corresponding multiple amplitude of a signal of a single resistor.

According to a further advantageous development, the conditioning of the generated signal includes smoothing, in particular through convolution of the generated signal by a Gaussian function. The advantage in this case is that this enables high-frequency components of the generated signal to be eliminated, thereby ultimately improving an evaluation of the generated signal. In this case the conditioning of the generated signal can also include lowpass filtering. The advantage here is that a signal-to-noise ratio of the generated signal is improved in order to achieve an improved detection of a magnetically marked object on the basis of the measured changes in the magnetic field.

According to a further advantageous development, the conditioning and/or evaluation of the generated signal includes a convolution of the signal using at least one derivative of the Gaussian function of the order of greater than or equal to 1. The advantage in this case is that a considerable improvement is achieved in determining extreme values on the basis of the generated and/or conditioned signal by the convolution using an n-th derivative of a Gaussian function with n≧1, where n is a natural number, in particular at n=2. As a result of the convolution, sections of the generated signal exhibiting a great change in terms of their slope are accentuated, i.e. applied to the generated signal, sections of the signal exhibiting a rapid and/or extreme change in the amplitude of the generated signal are highlighted. This then simplifies an evaluation of the signal or the determining of extreme values of the signal.

According to a further advantageous development, the conditioning of the generated signal is performed on the basis of a velocity of the objects and/or of dimensions of a sensor device. The advantage here is that these are known external variables, and these remain substantially constant and/or known during the time the method is performed. Said variables can then be referred to during the conditioning and evaluation of the signal, thereby increasing the accuracy of the method overall.

According to a further advantageous development, the threshold value is adjusted dynamically, in particular by statistical methods. The advantage in this case is that there is no need to carry out sample measurements in advance in order to specify a threshold value. Performing the method is considerably simplified as a result and the time for detecting a specific number of magnetically marked objects is shortened.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1a is a graph of a curve of a measured change in resistance of a sensor when a magnetically marked cell slides past as a function of time;

FIGS. 1b-d are schematic diagrams of a cell sliding past a sensor;

FIG. 2 is a schematic perspective diagram of a sensor device having a sensor in the form of a Wheatstone bridge;

FIG. 3a is a graph of a curve of a measured change in a bridge voltage of a Wheatstone bridge when a magnetically marked cell slides past as a function of time;

FIGS. 3b-d are schematic diagrams of a cell sliding past a sensor according to FIG. 2;

FIGS. 4a-d are graphs of time curves of the amplitudes of signals of a sensor after different operations of the method have been performed;

FIG. 5 is a schematic block diagram illustrating the execution sequence of a method according to a first embodiment variant; and

FIG. 6 is a schematic diagram illustrating a further embodiment variant of a sensor device having a sensor in the form of a Wheatstone bridge;

### DETAILED DESCRIPTION OF THE PREFERRED EMBODIMENT

Unless stated otherwise n the description relating to the figures, the same reference signs refer to the same or functionally identical elements.

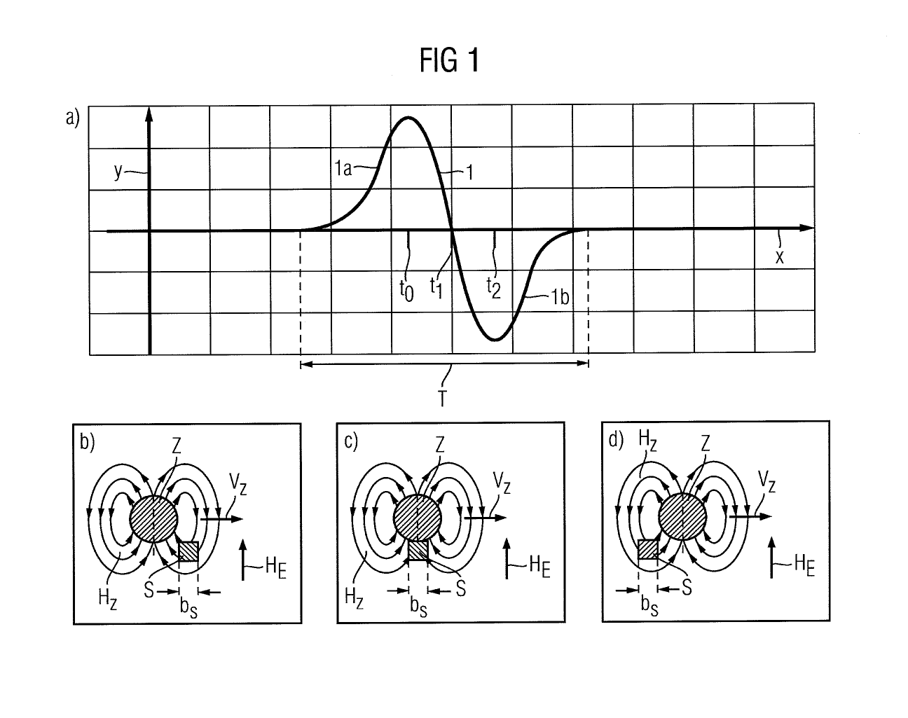

For a better understanding of the method and the individual embodiment variants in each case, a magnetic field H_{Z} of a magnetically marked cell Z is shown explicitly in FIGS. 1-6 for simplicity. Generally, however, a real magnetically marked cell Z has no magnetic field H_{Z} of its own, but is simply magnetically marked, for example by magnetizable substances, in particular by soft-magnetic or ferromagnetic particles. Introduced together with the cell Z in a magnetic field H_{E}, the particles generate a local magnetic field flux change which induces a change in the magnetic field H_{E} in the vicinity of the position of the cell Z, which change can be detected when the cell Z slides past a correspondingly embodied sensor.

The magnetic field H_{Z} of the cell Z shown in FIGS. 1-6 likewise effects a local change in the magnetic field H_{E} in the vicinity of the position of the cell Z. As described hereinabove, this can then be detected by a correspondingly embodied sensor. Accordingly, a cell Z having a magnetic field H_{Z} is to be understood in FIGS. 1-6 as a magnetically marked cell Z which, in a magnetic field H_{E}, generates a local change in the magnetic field H_{E} in the vicinity of its position.

FIG. 1a is a diagram showing a curve of a measured change in resistance of a sensor when a magnetically marked cell slides past as a function of time.

FIG. 1a is a graph on which the time is plotted on the x-axis X and a change in resistance of a sensor in the form of a magnetoresistive element S is plotted on the y-axis Y. If the magnetically marked cell Z having magnetic field H_{Z} according to FIG. 1b now approaches the magnetoresistive element or sensor S at a velocity v_{Z} and if an external magnetic field H_{E} is present vertically with respect to the direction of movement of the cell Z, the magnetoresistive sensor S generates a signal having the time curve 1 of the change in resistance according to FIG. 1a, if the sensor S detects a local change in the magnetic field H_{E} on account of the magnetic field H_{Z} of the cell Z: If the cell Z is still far away from the sensor S, the sensor S experiences no change in resistance, which is to say that the curve 1 runs along the x-axis or the change in resistance is zero

If the magnetically marked cell Z approaches the sensor S from left to right, the sensor S experiences a change in resistance due to the magnetic field H_{Z}, or more precisely the component of the magnetic field H_{Z} which is oriented in parallel with the direction of movement of the cell Z, and the curve 1 rises (curve 1a according to FIG. 1a). If the cell Z now moves further from left to right in the direction of the sensor S according to FIG. 1b, the curve 1 falls and reaches zero once again at a time t₁>t₀. At time t₁ the cell Z is located at the smallest possible distance from the sensor S. Because the axis of the magnetic field H_{Z} of the cell Z and a central axis of the sensor S are congruent, the sensor S measures no magnetic field H_{Z} of the cell Z and consequently also no change in resistance, since the sensor is embodied as sensitive only in the direction of the direction of movement of the cell Z; the change in resistance is zero.

If the cell Z now moves further from left to right according to FIG. 1c and FIG. 1d, the sensor S now measures a negative change in resistance 1b, because the field lines of the magnetic field H_{Z} of the cell Z are now oriented in the opposite direction in the vicinity of the sensor S. If the cell Z moves further away from the sensor S at the velocity v_{Z}, the negative change in resistance 1b decreases again, such that when the cell Z is at a sufficient distance from the sensor S, no further change in resistance is detected, i.e. the curve 1 is zero once again.

Overall, the curve 1 is embodied as point-symmetric at time t₁ and has extreme values of the change in resistance at times t₀ and t₂. The period duration T is essentially defined as the time interval starting from the point at which the curve 1a rises from zero, with extreme value at time t₀, the zero crossing t₁, the second extreme value of the negative change in resistance 1b at time t₂, to the once again substantially constant progression of the change in resistance equal to zero.

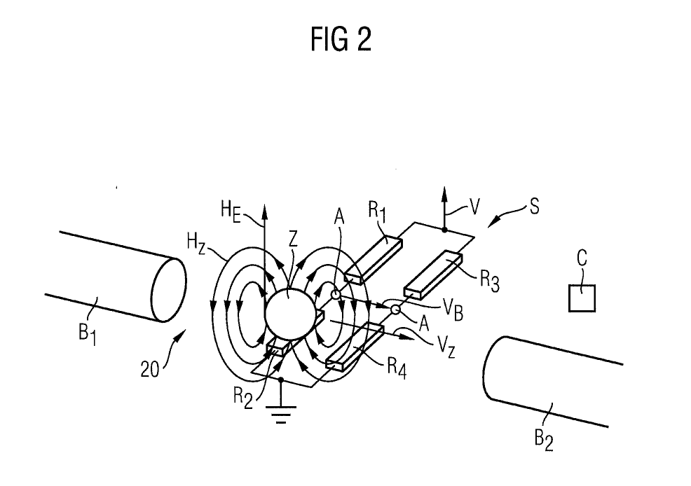

FIG. 2 is a schematic diagram showing a sensor device having a sensor in the form of a Wheatstone bridge.

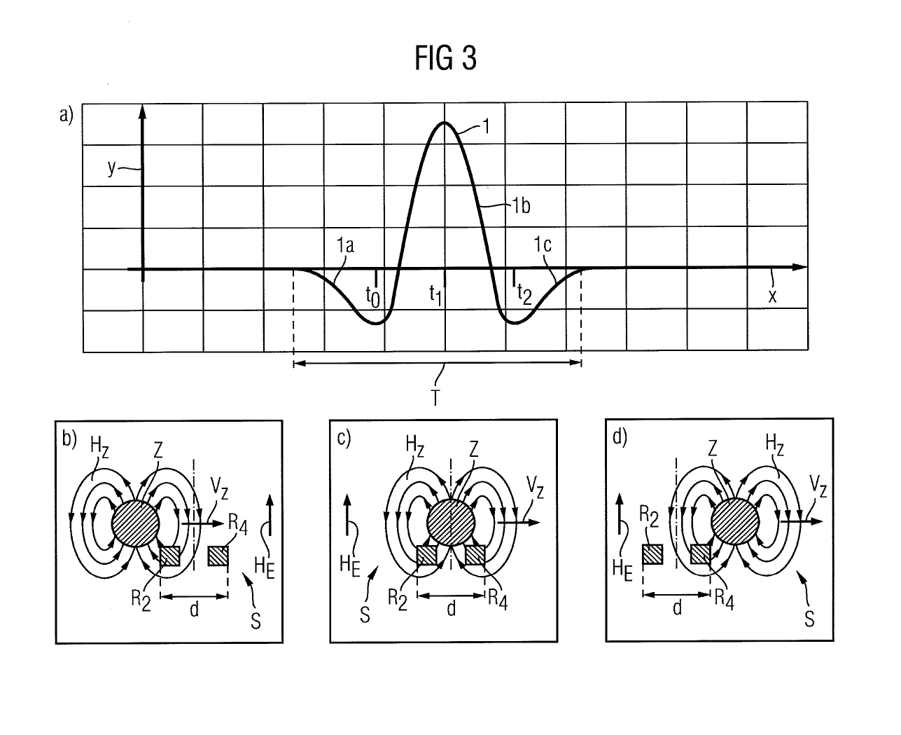

FIG. 2 is a schematic diagram showing a Wheatstone measuring bridge having resistors R₁-R₄ in a perspective view. In this case the cell Z is again magnetically marked, that is to say it has a magnetic field H_{Z}. The cell Z now moves at the velocity v_{Z} in succession over two resistors R₂, R₄ of the Wheatstone measuring bridge R₁-R₄ according to FIGS. 3b-d and in so doing generates a change in a bridge voltage V_{B} which is present between the resistors R₁, R₂, R₃, R₄ in accordance with the principle of a Wheatstone measuring bridge. The external magnetic field H_{E} is in this case oriented vertically with respect to the direction of the velocity v_{Z} of the cell Z.

Also indicated in FIG. 2 are thin capillary tubes B₁, B₂ which serve to supply the cell Z to the sensor S in the form of the Wheatstone measuring bridge having resistors R₁, R₂, R₃, R₄ and also to remove the cell Z. Of course, any other practicable ways of supply or removal are also possible. Also shown is an evaluation unit in the form of a computer C, which is used for analyzing a conditioned signal. In this case the computer C also handles the conditioning F₁, F₂, F₃, F₄ of a signal V_{B} of the sensor S and for this purpose is connected to terminals A for tapping the bridge voltage V_{B} of the Wheatstone measuring bridge (not shown).

FIG. 3a shows a diagram of a curve of a measured change in a bridge voltage of a Wheatstone bridge when a magnetically marked cell slides past as a function of time.

FIG. 3a now shows the curve of the change in a bridge voltage V_{B}, with the change in the bridge voltage V_{B} being plotted on the y-axis Y and the time being plotted on the x-axis X. The curve 1 shows the progression of the change in the bridge voltage V_{B} as the cell Z slides past the resistors R₂, R₄ of the Wheatstone measuring bridge R₁, R₂, R₃, R₄. This is as follows:

If the cell Z moves with its magnetic field H_{Z} toward the two resistors R₂, R₄ according to FIG. 3b and analogously as in FIGS. 1b-1d from left to right at the velocity v_{Z}, the resistor R₂ is first to be impinged upon by the magnetic field H_{Z} of the cell Z. In this case a negative bridge voltage V_{B} having curve 1a is generated which has an extreme value at time t₀ according to FIG. 3a. If the cell Z moves further from left to right according to FIG. 3c, the negative change in the bridge voltage V_{B} weakens again and then rises in the subsequent time curve up to a positive extreme value at time t₁. At time t₁ the cell Z is now located between the two resistors R₂ and R₄ which are spaced apart from each other by the distance d, in other words the cell Z is located substantially centrally between the two resistors R₂ and R₄.

If the cell Z now moves further from left to right according to FIG. 3d, the subsequent curve 1b of the positive change in the bridge voltage V_{B}, diminishes again, passes through a zero point and becomes negative once more in the subsequent time curve 1c. The curve 1c in turn has an extreme value at time t₂. At time t₂ only the resistor R₄ is (still) impinged upon by the magnetic field H_{Z} of the cell Z, analogously to the resistor R₂ according to FIG. 3b.

Overall, therefore, the curve 1 of the change in the bridge voltage V_{B} is mirror-symmetric at time t₁. The period duration T is defined in accordance with the description relating to FIG. 1, namely as the time period from the first change in the bridge voltage V_{B} that is different from zero until the change in the bridge voltage V_{B} is zero once again and the cell Z has slid past the two resistors R₂, R₄.

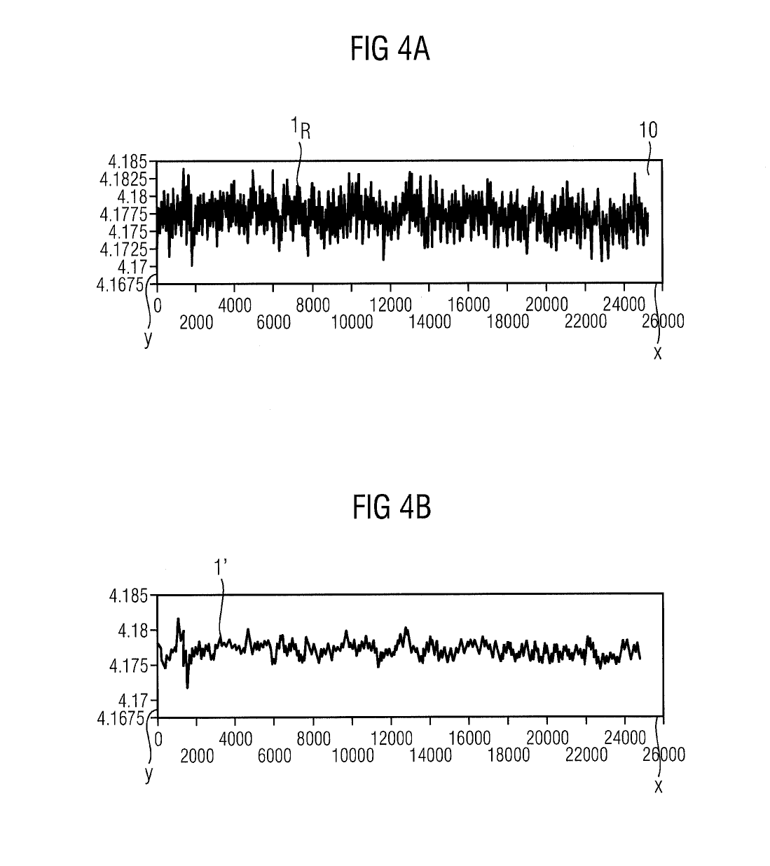

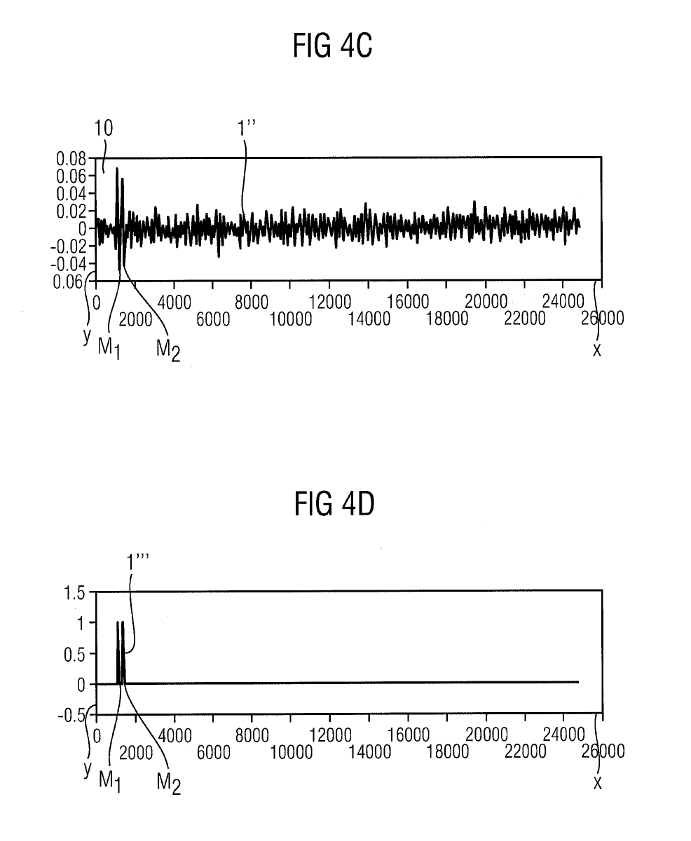

FIG. 4 shows time curves of the amplitudes of signals of a sensor after different operations of the method have been performed.

FIG. 4a shows an x-y diagram, wherein the x-axis is a time axis and the y-axis Y represents a positive amplitude of a signal 1_{R}, generated by a sensor S according to FIGS. 1b-1d. In this case two magnetically marked cells Z have slid or moved past the sensor S between times t=0 and t=2000. A threshold value 10 is also specified at an amplitude of +4.1825. A plurality of peaks of the amplitude of the signal 1_{R} which exceed the threshold value 10 can be seen. These are to be seen not only in the range between t=0 and t=2000, but also at times t>2000 at which no cell Z has passed the sensor S. In order to condition and evaluate the signal 1_{R}, the latter is now digitized and/or converted into a time-discrete signal 1. In this case it is necessary to comply with the Nyquist-Shannon sampling theorem as a function of the velocity v_{Z} at which a cell Z slides past or passes the sensor S and the period duration T resulting therefrom according to FIGS. 3a and 1a.

Subsequently thereto, the digitized signal 1 is smoothed in order to eliminate high-frequency components. Toward that end the digitized signal 1 according to FIG. 4a is convoluted using a Gaussian function, the thus smoothed signal 1′ being shown in FIG. 4b. The smoothed signal 1′ is now convoluted using a second partial derivative of a Gaussian function. As a result of the preceding discretization of the signal 1′ the curve 1″ of the convoluted signal is computed on the basis of a discrete sum of a product of smoothed signal 1′ and second derivative of the Gaussian function. The index of summation of the discrete sum is in this case dependent on parameters, i.e. external, known variables, which are used to optimize the smoothing or a further extreme value filtering. These include inter alia a laminar flow velocity or the velocity v_{Z} at which the cell Z moves. If the sensor S is embodied as a Wheatstone bridge R₁, R₂, R₃, R₄, the respective distance d of the resistors R₂, R₄ in parallel with the direction of movement of the cell Z can be used as a further parameter. If a single resistor R is present, its width b can be used.

FIG. 4c now shows a discretized, smoothed signal 1″ convoluted using a second derivative of a Gaussian function in the corresponding curve according to FIGS. 4a and 4b. Local maxima M₁, M₂, which correspond to a cell Z sliding past the sensor S, can now be seen. The local maxima M₁, M₂ stand out clearly in terms of their amplitude from the further curve of the signal 1″. A static threshold value 10 is specified in order now to decide whether a cell Z is detected or not. In FIG. 4c this is 0.04. Thus, only the amplitudes of the signal 1″ according to FIG. 4c are evaluated whose amplitude is greater than 0.04. FIG. 4d shows an amplitude of the signal 1′″ following filtering using the above-cited threshold value 10. Only two values of the variable 1 are now to be seen, corresponding to the maxima M₁ and M₂ of FIG. 4c. Filtering according to the threshold value 10 therefore yields a logic 1, as shown in FIG. 4d, when a cell Z slides past the sensor S.

Additional information concerning physical properties of the cell Z, such as for example diameter of the cell Z, etc., can also be obtained from the respective amplitude value according to FIG. 4a, at the maxima M₁, M₂ above the threshold value 10. According to FIG. 4d it is also possible by using the threshold value filtering to measure just the number of cells Z that have passed the sensor S. In addition it is possible to improve the reliability of the threshold value filtering further by for example a further smoothing of the signal 1″ according to FIG. 4c.

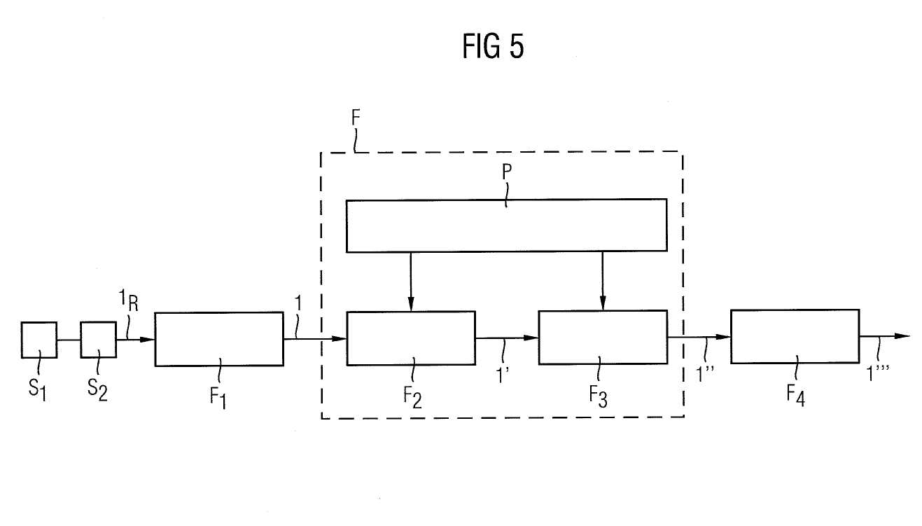

FIG. 5 is a schematic diagram illustrating the execution sequence of a method according to a first embodiment variant.

FIG. 5 shows a method according to the first embodiment variant. If the magnetically marked object Z is moved in a magnetic field H_{E} in S₁, a local change in the magnetic field H_{E} caused by the object Z on account of its movement past a sensor S is subsequently measured in S₂. The signal 1_{R} generated by the sensor S is first digitized in an analog-digital converter F₁ and converted into a time-discrete signal 1. The digitized signal 1 is then smoothed by a filter F₂, the smoothed signal 1! is conditioned in a further filter F₃ in order to determine the extreme values by convolution of the signal 1′ using a second derivative of a Gaussian function. The resulting signal 1″ is then filtered on the basis of a threshold value in a threshold value filter F₄.

The signal 1′″ output by the threshold value filter 4 then corresponds for example to the curve according to FIG. 4d. The signal 1″ output by the extreme value filter F₃ corresponds to the signal 1″ according to FIG. 4c, the signal 1′, output by the filter F₂, in this case has the curve according to FIG. 4b. The signal 1 according to FIG. 4a in this case corresponds to the signal 1 output by the analog-digital converter F₁. The parameters P for a filter F, including filters F₂ and F₃, correspond to external known variables, for example to the laminar flow velocity or the velocity v_{Z} at which an object Z moves past a sensor S, to a width b of the sensor S, or to a distance d of resistors R₁, R₂, R₃, R₄ of a Wheatstone measuring bridge.

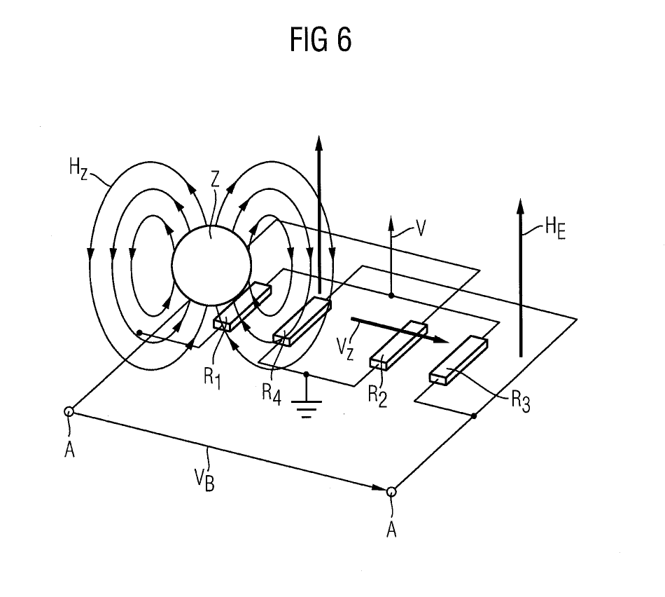

FIG. 6 is a schematic diagram illustrating a further embodiment variant of a sensor device having a sensor in the form of a Wheatstone bridge.

Finally, FIG. 6 is a schematic diagram illustrating a Wheatstone measuring bridge having resistors R₁-R₄ in a perspective view. In this case the cell Z is again magnetically marked. The cell Z now moves at the velocity v_{Z} in succession over four resistors R₁, R₄, R₂, R₃ of the Wheatstone measuring bridge R₁-R₄ analogously to FIGS. 3b-d and in so doing generates a change in a bridge voltage V_{B} which is present between the resistors R₁, R₂, R₃, R₄ in accordance with the principle of a Wheatstone measuring bridge. The external magnetic field H_{E} is in this case oriented vertically with respect to the direction of the velocity v_{Z} of the cell Z. The change in the bridge voltage V_{B} in this case has substantially the same curve as according to FIG. 3a. The distance d according to FIGS. 3b-3d, which may be relevant as a parameter for the filtering, is in this case not the distance between the two resistors R₂, R₄, but the distance between the center point of the distance between the resistors R₁, R₄ and the center point of the distance between the resistors R₂, R₃ along the direction of movement of the cell Z.

The further configuration of the device according to FIG. 6, i.e. thin capillary tubes, etc., corresponds to that of FIG. 2.

A description has been provided with reference to aforementioned exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for continuously detecting magnetically marked biological objects, comprising:
moving at least one magnetically marked object in a magnetic field;
measuring a local change in the magnetic field caused by the magnetically marked object;
generating a digitized signal based on the local change in the magnetic field;
conditioning the digitized signal to produce a smoothed signal, by at least one convolution of the digitized signal using a Gaussian function; and
evaluating the smoothed signal by determining maximum values of the smoothed signal and comparing the maximum values with a predefined threshold value, which, if exceeded, indicates detection of the object.

12. The method as claimed in claim 11, wherein said magnetic field is oriented substantially vertically with respect to a direction of movement of the object and changes in the magnetic field, caused by changes in a magnetic flux density on account of the magnetically marked object, are measured in parallel with the direction of movement of the object.

13. The method as claimed in claim 12, wherein said measuring of the local change in the magnetic field uses a Wheatstone bridge.

14. The method as claimed in claim 13, wherein at least one of said conditioning and said evaluating of the digitized signal includes a convolution of the digitized signal using at least one derivative of the Gaussian function of an order of at least one.

15. The method as claimed in claim 14, wherein said conditioning of the digitized signal is performed based on a velocity of the objects and/or on dimensions of a sensor.

16. The method as claimed in claim 15, further comprising dynamically adjusting the threshold value using statistical methods.

17. A device for continuously detecting magnetically marked biological objects, comprising
a sensor device continuously measuring a local change in a magnetic field caused by magnetically marked objects moving in the magnetic field;
means for supplying at least one object to the sensor device;
means for removing the at least one object from the sensor device;
means for producing a conditioned signal by conditioning a sensor signal generated by the sensor device, using a Gaussian function for at least one-time convolution of the sensor signal; and
an evaluation unit determining extreme values of the conditioned signal, comparing the extreme values with a predefined threshold value and indicating detection of the object when the predefined threshold value is exceeded.

18. The device as claimed in claim 17, wherein the sensor device includes
means for generating the magnetic field,
a sensor, oriented vertically with respect to a direction of the magnetic field, measuring local changes in the magnetic field caused by the at least one object in parallel with a direction of movement of the at least one object when the at least one object moves within range of the sensor, and
means for providing the sensor signal.

19. The device as claimed in claim 18, wherein the sensor is a Wheatstone measuring bridge.

20. A method of processing a sensor signal, comprising:
determining extreme values of the sensor signal generated by a sensor continuously measuring a magnetic field when magnetically marked objects move in a magnetic field within range of the sensor;
producing a conditioned signal by at least one convolution of the sensor signal using an n-th derivative of a Gaussian function with n≧0, where n is a natural number including the number zero; and
detecting at least one of the magnetically marked objects when the conditioned signal exceeds a threshold value.
